(19) United States
(12) Patent Application Publication
(10) Pub. No.: US 2005/0071564 A1
(43) Pub. Date: Mar. 31, 2005

(54) Reduction of cache miss rates using shared private caches

(75) Inventor: David A. Luick, Rochester, MN (US)

Correspondence Address: Robert R. Williams;IBM Corporation, Dept. 917, 3605 Highway 52 North, Rochester, MN, 55901-7829, US

(73) Assignee: International Business Machines Corporation, Armonk, NY (US)

(21) Appl. No.: 10/670,715

(22) Filed: Sep. 25, 2003

(51) Int. Cl. G06F 12/00

(52) U.S. Cl. 711/121; 711/130; 711/136

(57) ABSTRACT

Methods and systems for reducing cache miss rates for cache are disclosed. Embodiments may include a computer system with one or more processors and each processor may couple with a private cache. Embodiments selectively enable and implement a cache re-allocation scheme for cache lines of the private caches based upon a workload or an expected workload for the processors. In particular, a cache miss rate monitor may count the number of cache misses for each processor. A cache miss rate comparator compares the cache miss rates to determine whether one or more of the processors have significantly higher cache miss rates than the average cache miss rates within a processor module or overall. If one or more processors have significantly higher cache miss rates, cache requests from those processors are forwarded to private caches that have lower cache miss rates and have the least recently used cache lines.

### BACKGROUND OF THE INVENTION

1. Field of the Invention

The present invention generally relates to the field of multiprocessor computer systems. More particularly, the present invention relates to methods, systems, and media for reducing cache miss rates of processors to caches such as private caches.

2. Description of the Related Art

Parallel processing generally refers to performing multiple computing tasks in parallel. Traditionally, parallel processing required multiple computer systems with the resources of each computer system dedicated to a specific task or allocated to perform a portion of a common task. For instance, one computer system may be dedicated to sales systems, another to marketing systems, another to payroll systems, etc.

However, recent advances in computer hardware and software technologies have resulted in single computer systems capable of performing highly complex parallel processing by logically partitioning the system resources to different tasks. In a logically partitioned (LPAR) computer system, for example, available system resources, such as processors, are allocated among multiple partitions, allowing each partition to be operated independently of the other.

The multiple processors may reside on one or more processor modules such as symmetric multiprocessing (SMP) modules that typically include at least two levels of caches. Caches are typically accessed much faster than main memory, often located on the processor module, or within the processors. Caches act as buffers to retain recently used instructions and data to reduce the latencies involved with retrieving the instructions and data from main memory every time the instructions and data are needed. More specifically, a cache typically operates by retaining the more often used memory lines from main memory. A memory line is the minimum readable unit of data from the main memory such as eight bytes and a cache line is the corresponding unit in cache. Cache lines are implemented to store memory lines so the memory lines do not have to be retrieved from main memory each time the memory lines are used.

The memory lines that are more often used will be stored in the cache because the cache is generally smaller than main memory. This is generally accomplished by tracking the least recently used (LRU) entries, or cache lines, and replacing the LRU cache lines with memory lines associated with recent cache requests that cannot be satisfied by the current contents of the cache. Such requests are often called cache misses because the processor sent the request to the cache and missed an opportunity to retrieve the contents of the memory lines from the cache.

Processors may include a level one (L1) cache to retain, e.g., copies of repeatedly accessed instructions from main memory, reducing latencies of potentially thousands of cycles for accessing main memory to a few cycles incurred while accessing the cache. However, L1 cache is generally small because area used within the processor is expensive.

A level two (L2) cache often resides on the processor module, physically close to the processor, offering significantly reduced latencies with respect to access of main memory. L2 cache may be larger than the L1 cache since it is less costly to manufacturer and may be configured to maintain, e.g., a larger number of the recently used memory lines.

The L2 cache may be implemented as a large, shared cache for more than one of the processors in the processor module or as separate, private caches, for each of the processors in the module. A large, shared L2 cache is beneficial for workload demands on processors that involve accesses to a large number of memory lines. For example, when a processor is accessing a large database, a large number of memory lines may be repeatedly accessed. However, if the L2 cache is not sufficiently large to hold that large number of repeatedly accessed memory lines, the memory lines accessed first may be overwritten and the processor may have to request those memory lines from main memory again. Thus, the large, shared cache advantageously allows some processors to store a larger number of memory lines in cache.

On the other hand, accesses to a small, private cache involves less latency than a larger, shared cache since there are less lines of cache to sort through and because the smaller, private L2 caches can be located physically close to the processor that generates the requests. Thus, private caches are advantageous when a small number of memory lines are repeatedly accessed by the processors and the private caches are sufficiently large to hold that small number of repeatedly accessed memory lines.

Therefore, there is a need for methods, systems, and media for reducing cache miss rates, preferably offering the advantages of both the large, shared cache and the private caches based upon the actual or expected workloads of individual processors.

### SUMMARY OF THE INVENTION

Embodiments of the invention generally provide methods, systems, and media to reduce cache miss rates. One embodiment provides a method for reducing cache miss rates for more than one processors, wherein the more than one processors couple with private caches. The method generally includes determining the cache miss rates of the more than one processors; comparing the cache miss rates of the more than one processors; and allocating cache lines from more than one of the private caches to a processor of the more than one processors based upon the difference between the cache miss rate for the processor and the cache miss rates of other processors.

Another embodiment provides a method for reducing cache miss rates for more than one processors, wherein the more than one processors couple with private caches. The method includes monitoring the cache miss rates of the more than one processors; comparing the cache miss rates of the more than one processors to determine when a cache miss rate of a first processor associated with a first private cache of the private caches exceeds a threshold cache miss rate for the more than one processors; forwarding a cache request associated with the first processor to a second private cache of the private caches in response to determining the cache miss rate exceeds the threshold cache miss rate; replacing a cache line in the second private cache with a memory line received in response to the cache request; and accessing the cache line in response to an instruction from the first processor.

Another embodiment provides an apparatus for reducing cache miss rates for more than one processors, wherein the more than one processors couple with private caches. The apparatus generally includes a cache miss rate monitor to determine the cache miss rates of the more than one processors; a cache miss rate comparator to compare the cache miss rates; and a cache request forwarder to allocate cache lines from more than one of the private caches to a cache request of a processor of the more than one processors based upon the difference between the cache miss rate for the processor and the cache miss rates of other processors.

Another embodiment provides an apparatus for reducing cache miss rates. The apparatus generally includes more than one processors to issue cache requests; more than one private caches, each individually coupled with one of the more than one processors; a cache miss monitor to associate a cache miss rate with each of the more than one processors; a cache miss comparator to determine when at least one of the cache miss rates exceeds a threshold; and a cache request forwarder to forward a cache request from a processor of the more than one processors that is associated with a cache miss rate determined to exceed the threshold, to a private cache of the more than one private caches associated with another processor of the more than one processors.

Still another embodiment provides a system for reducing cache miss rates. The system includes a processor module comprising a first processor coupled with a first private cache and a second processor coupled with a second private cache; a cache miss rate monitor to count cache misses associated with the first processor and the second processor; a cache miss rate comparator to compare the cache misses associated with the first processor against cache misses associated with the second processor; and a cache request forwarder to forward cache requests from the first processor to the second private cache when a number of cache misses associated with the first processor, related to the first private cache, exceeds a number of cache misses associated with the second processor.

Another embodiment provides a computer readable medium containing a program which, when executed, performs an operation, including determining cache miss rates of more than one processors; comparing the cache miss rates; and allocating cache lines from more than one of the private caches to a processor of the more than one processors based upon a difference between the cache miss rate for the processor and the cache miss rates of other processors.

Yet another embodiment provides a computer readable medium containing a program which, when executed, performs an operation, including monitoring cache miss rates of more than one processors; comparing the cache miss rates of the more than one processors to determine when a cache miss rate of a first processor associated with a first private cache exceeds a threshold cache miss rate for the more than one processors; forwarding a cache request associated with the first processor to a second private cache in response to determining the cache miss rate exceeds the threshold cache miss rate; replacing a cache line in the second private cache with a memory line received in response to the cache request; and accessing the cache line in response to an instruction from the first processor.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is an embodiment of a system for reducing cache miss rates of private L2 cache.

FIG. 2 depicts an example of an apparatus having multiple processors for reducing cache miss rates associated with caches coupled with the processors.

FIG. 3 depicts a flow chart for an exemplary method for reducing cache miss rates of cache.

### DETAILED DESCRIPTION OF THE PREFERRED EMBODIMENTS

The following is a detailed description of embodiments of the invention depicted in the accompanying drawings. The embodiments are examples and are in such detail as to clearly communicate the invention. However, the amount of detail offered is not intended to limit the anticipated variations of embodiments, but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, methods, systems, and media for reducing cache miss rates for cache are contemplated. Embodiments may include a computer system with one or more processors and each processor may couple with a private cache. Embodiments selectively enable and implement a cache re-allocation scheme for cache lines of the private caches based upon a workload or an expected workload for the processors. In particular, some embodiments may include a cache miss rate monitor, a cache miss rate comparator, and a cache request forwarder. The cache miss rate monitor may count the number of cache misses for each processor. The cache miss rate comparator compares the cache miss rates to determine whether one or more of the processors have significantly higher cache miss rates than the average cache miss rates within a processor module or overall. If one or more processors have significantly higher cache miss rates, the cache forwarder forwards cache requests from those processors to private caches that have lower cache miss rates and have the least recently used cache lines.

The cache forwarder may select the number of least recently used cache lines for re-allocation based upon the difference in cache miss rates associated with the processors. The cache forwarder then replaces the least recently used cache lines with contents of memory lines associated with the incoming requests from the processors having the higher cache miss rates. Utilizing cache lines of neighboring private caches may involve two or three times the latency as utilizing a private cache directly coupled with the processor but that latency is still significantly less than the latency involved with accessing main memory.

In some embodiments, the cache requests of the processors with higher cache miss rates are prioritized and selectively forwarded to private caches of processors having lower cache miss rates based upon the assigned priorities. For example, a cache request designed to modify a memory line may have a lower priority than a cache request for an instruction to be executed or for data to execute an instruction because latencies involved with requests for instructions or data to execute instructions have a greater impact on processing capacity of the corresponding processors. Less latency is involved with accesses to private cache closely coupled to the processor. Similarly, speculative cache requests may retrieve data that may not be used so further embodiments associate lower priorities with speculative cache requests.

In many embodiments, a software application such as the operating system may determine when to enable a cache re-allocation scheme for a processor. For instance, an operating system may maintain previously characterized workloads, or a history of cache requests for certain tasks. When the history indicates that a task demands a larger number of memory lines or typically causes a greater number of cache misses, the software application may enable the cache re-allocation scheme for selected processors. In particular, the software application may communicate with the cache request forwarder to indicate that cache requests for processors assigned to the task should be forwarded to private caches of other processors.

In further embodiments, the processors may maintain a count of cycles to indicate when a cold start warm-up period for a task has ended and couple with the cache miss rate monitor to initiate a count of cache misses after the cold start warm-up period. Software may set a bit to indicate when a new task is assigned to the processor, the processor may be adapted to reset the cold start count whenever the processor receives an interrupt. Or, the processor may be adapted to recognize a sequence of instructions indicative of a task switch. As a result, cache requests may not be forwarded to private caches of other processors before the cache miss rate for the processors have reached a steady state. For instance, when a processor begins a new task, none or few of the cache lines stored in a private cache may satisfy cache requests. Therefore, the transient cache miss rate for the task may be unusually high while the steady state cache miss rate for the task may not be significantly higher than the average cache miss rate for all the processors. Waiting a number of cycles before determining the cache miss rate for each processor avoids a premature determination that a task running on a processor would operate more efficiently with access to additional cache lines.

While specific embodiments will be described below incorporating functions into specific hardware configurations such as processor modules having four processors in a computer system, those of skill in the art will realize that embodiments of the present invention may advantageously implement similar functions for two or more processors via hardware or software, advantageously reducing cache miss rates. More generally, embodiments of the present invention implement functions to allow processors to share cache lines of private caches to reduce overall latencies involved with accessing memory lines from main memory.

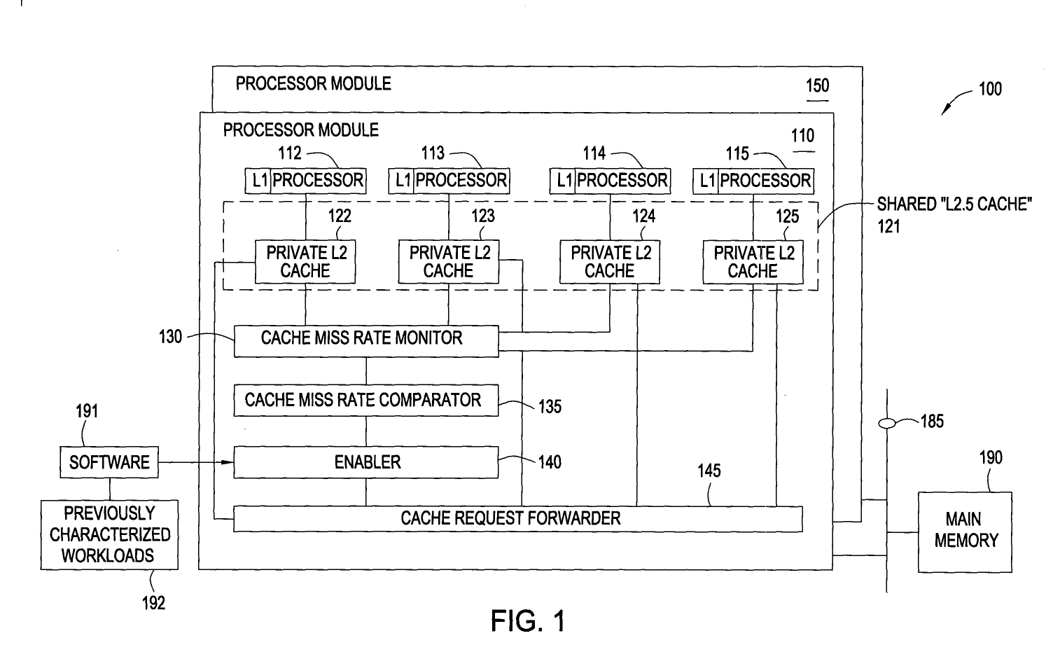

One embodiment of the invention is implemented as a program product for use with a computer system such as, for example, the system 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

### An Exemplary System

Turning now to the drawings, FIG. 1 depicts an embodiment of a system 100 for reducing cache misses in processor modules 110 through 150. In this embodiment, reducing cache misses involves reducing cache misses for a processor such as processor 112 to private, level two (L2) cache 122 by a cache line reallocation scheme that allows any selected processor to store cache lines in private, L2 cache 122 even though private, L2 cache 122 is initially (or by default) allocated as private cache to processor 112. In one mode of operation, the cache re-allocation scheme forwards cache requests from a processor that result in a cache miss to the least recently used cache line of another private cache. In effect, the cache re-allocation scheme presents the private, L2 caches 122-125 as a larger, shared “L2.5” cache 121.

In one mode of operation, a software application, such as software 191, may implement the cache reallocation scheme by re-allocating least recently used cache lines to another processor based upon the task that the processor is performing, an application running on the computer system, a particular user that is logged into or using the computer system, or a history of use by a task, an application, or a user. In a further mode of operation, the cache line reallocation scheme may be enabled by software or hardware in response to the number of cache misses realized by a particular processor that is executing a particular task. For example, each processors' cache miss rate may be monitored and when the cache miss rate exceeds a threshold rate such as a rate greater than the average cache miss rate of other processors, a cache line reallocation scheme may be enabled for that processor.

In any case, system 100 may include processor modules 110 and 150, backside bus 185, and main memory 190. Processor modules 110 and 150 may communicate with one another and with main memory 190 via backside bus 185. For example, when a processor realizes a cache miss, a request for the corresponding memory line may be transmitted via backside bus 185 to main memory and the contents of the memory line may be returned to the processor and/or cache for the processor via backside bus 185.

Processor modules 110 and 150 may include substantially the same hardware so the hardware of processor module 110 will be discussed below as an illustration of how hardware may be used to implement the present invention. In further embodiments, any number of processor modules may be attached to backside bus 185 and any number of processors may be included within each processor module.

Illustratively, processor module 110 includes processors 112 through 115, private L2 cache 122 through 125, cache miss rate monitor 130, cache miss rate comparator 135, enabler 140, and cache request forwarder 145. Processors 112 through 115 each couple with a private L2 cache 122 through 125 and are designed to execute one or more tasks related to software applications. In particular, to execute the instructions of a task, processors 112 through 115 request the instructions along with any data that is necessary to execute the instructions from memory. When the instructions and data are received from memory, the instructions and data are stored in registers and executed. Commonly or recently requested instructions and data may be stored in one or more levels of cache to reduce the latency involved with retrieving the instructions and data for execution. In particular, each processor includes a level one (L1) cache on the processor chip to store the most commonly used instructions and data. The private L2 caches coupled with processors 112 through 115 maintain additional commonly used instructions and data. For example, when a processor needs an instruction or data to execute a task, the processor generates a cache request, which is first forwarded to the L1 cache. When the L1 cache does not have the data, i.e. a cache miss, the cache request is forwarded to private L2 cache directly coupled with the processor. When the private L2 cache misses, in the present embodiment, the cache request may be sent to another private L2 cache, forwarded to main memory 190, or both.

Cache miss rate monitor 130 tracks the cache miss rate associated with each of processor 112 through 115. Each time a cache miss in a private L2 cache is encountered, the cache miss monitor 130 may increment a counter. For example, a cache request by processor 112 that results in a cache miss is forwarded to private L2 cache 122. If the cache request results in a cache miss at private L2 cache 122, a counter in cache miss rate monitor 130 is incremented.

The cache miss rates of each processor are forwarded to cache miss rate comparator 135 to determine whether one or more of the cache miss rates exceed a threshold. In some embodiments, the threshold is based upon a calculated average of the instantaneous cache miss rates associated with each processor 112 through 115. Cache miss rate comparator 135 compares the cache miss rate of each processor 112 through 115 against the threshold and if one or more of the cache miss rates exceed the threshold, cache miss rate comparator 135 sets a bit in enabler 140 to enable a cache line reallocation scheme for the corresponding processor(s).

Enabler 140 may comprise a register to store flags associated with each processor 112 through 115. Each flag represents a status regarding whether a cache line reallocation scheme is enabled for one or more of processors 112 through 115. For example, enabler 140 may include four bits in the present embodiment. A first bit may correspond to whether the cache line reallocation scheme is enabled for processor 112. Similarly, bits two through four may indicate whether the cache line reallocation scheme is enabled for processors 113 through 115.

Flags of enabler 140 may be set via cache miss comparator 135 or by software 191. Software 191, for instance, may set flags in enabler 140 based upon the task that a processor is performing, the application running on the computer system, a particular user that is using the computer system, or a previously characterized workload 192, an application, or a user. Software 191 may also set flags for processors based upon the number of cache misses realized by a particular processor when executing a particular task.

For example, when a user logs into the computer system, a software application executed by the system, software 191, may access a historical use file such as previously characterized workload 192 and determine that the user typically runs applications that cause processors of processor module 110 and 115 to generate a significant number of cache misses when limited to private L2 caches. Software 191 may then set flags in enabler 140 and a corresponding enabler in module 150 to cause cache requests that result in cache misses to be forwarded to least recently used cache lines of alternative private L2 caches, essentially treating the private L2 caches as a single, large, L2 cache (e.g., an L2.5 cache 121).

However, in some of these embodiments, cache request forwarder 145 selectively forwards cache requests to alternative private L2 caches, maintaining most often used cache lines such as those used for instructions, in the private L2 caches directly coupled with the processors. Less often used cache lines are moved to alternative private L2 caches within the same processor module or to remote processor modules, advantageously offering many of the benefits of private L2 caches and the benefits of a single, large, L2 cache.

Cache request forwarder 145 may distribute cache lines to processors of processor module 110 and/or 150 based upon the actual or anticipated workloads of processors on processor modules 110 and 150. Cache request forwarder 145 may select a private L2 cache to receive a cache request based upon least recently used cache lines and forward the cache request to the private L2 cache. In particular, when a flag of enabler 140 indicates that the cache line reallocation scheme is enabled for processor 112, cache request forwarder 145 may forward cache requests that miss private L2 cache 122 from processor 112 to another private L2 cache within processor module 110 or another processor module such as processor module 150.

For example, at steady state, each of the processors, 112 through 115, and processors of processor module 150 may maintain substantially the same cache miss rate such as one cache miss for every 1000 cycles. Then, processor 112 begins execution of a database application and the cache miss rate for processor 122 increases to four cache misses per 1000 cycles. Cache miss rate comparator 135 or the operating system recognizes the increase in the number of cache misses for processor 112 with respect to the cache miss rates of other processors and sets a bit in enabler 140, enabling the cache re-allocation scheme for processor 112. Cache request forwarder 145 now selects least recently used cache lines to provide processor 112 with access to cache lines of private L2 caches associated with other processors. Any allocation may be variable, e.g., based upon cache miss rates. For example, an allocation to processor 112 may include four-sevenths of the total number of cache lines in the private L2 cache of processor module 110 or four-elevenths of the cache lines in private L2 cache on processor modules 110 and 150.

Cache request forwarder 145 may select the targeted private L2 cache based upon the processor module containing the private L2 cache. For instance, in one mode of operation, cache request forwarder 145 may select the least recently used cache line from private L2 cache 122, 123, 124, and 125, whereas a cache request forwarder on processor module 150 will select from the least recently used cache line from private L2 cache on processor module 150. In another mode of operation, cache request forwarder 145 may select the private L2 cache based upon the least recently used cache line regardless of the processor module on which the private L2 cache is located. In a further mode of operation, cache request forwarder 145 may select the least recently used cache line from processors that do not have the cache line reallocation scheme enabled.

In several embodiments, hardware, such as processors 112 through 115, or a software application may assign priorities to cache requests. In such embodiments, cache request forwarder 145 may select a cache request to forward to another private L2 cache or select a private L2 cache to receive a cache request based upon the priority associated with the cache request and the module comprising the private L2 cache. For example, cache requests for instructions and data to be executed may be associated with one or more high priority levels, whereas speculative cache requests and requests to load a memory line so that the memory line may be modified may be associated with one or more low priority levels. When the cache line reallocation scheme is enabled for processor 112, for instance, cache request forwarder 145 may not forward cache requests associated with highest priority level to another private L2 cache. So memory lines for those requests may be retrieved from main memory and stored in the least recently used cache lines of private L2 cache 122. Cache request forwarder 145 may forward cache requests categorized in the next lowest high priority level to the least recently used cache line associated with private L2 caches 123, 124, and 125. And cache request forwarder 145 may forward cache requests with a low priority level to either the least recently used cache lines of processor module 150 or the least recently used cache lines regardless of the processor module on which the corresponding private L2 cache resides.

In some embodiments, the processor or software may set a priority for the cache request by storing bits in, e.g., a translation look-aside buffer (TLB) for each private L2 cache. For instance, a software application may store the bits in a page table for translating addresses associated with instructions and data for execution by a processor. The bits may then be copied into the TLB when the processor is executing a task associated with the instructions and data. Similarly, the processor may set control bits in the TLB. The bits may, e.g., indicate when a memory line associated with a cache request is to remain in the private L2 cache directly coupled with the processor and when the memory line associated with the cache request is eligible for relocation to another private L2 cache.

### An Exemplary Processor Module

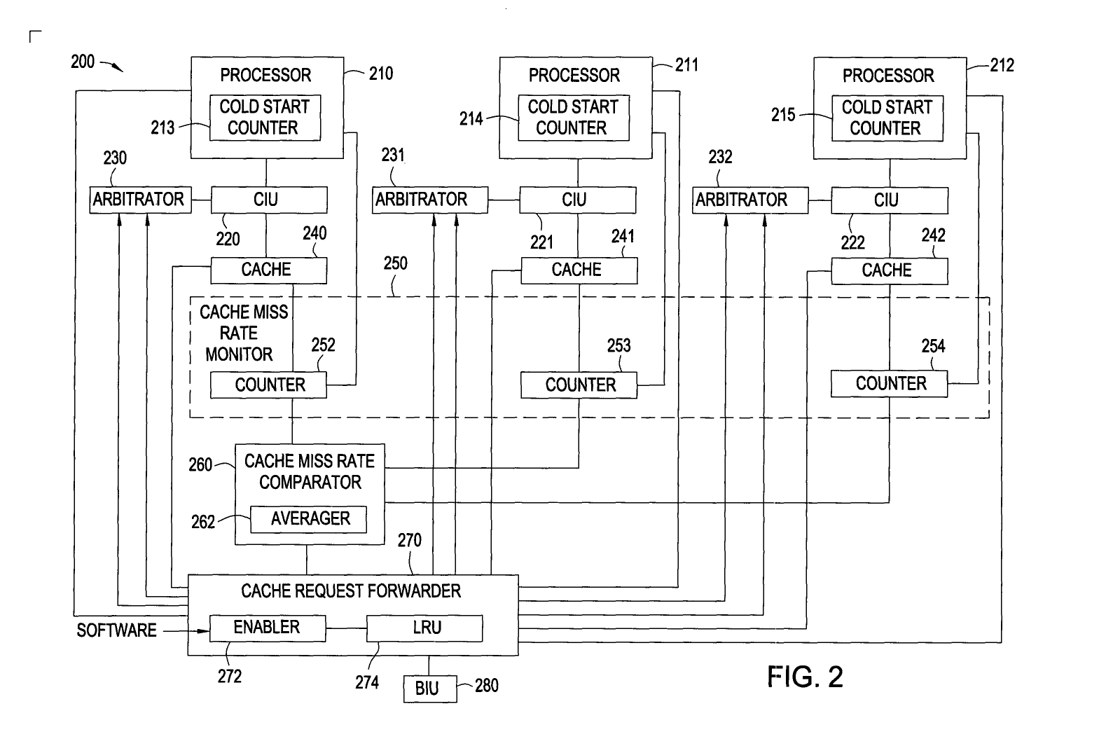

FIG. 2 illustrates a more detailed embodiment of a processor module 200 to implement the present invention, such as processor module 110 in FIG. 1. Processor module 200 includes processors 210 through 212, cache interface units (CIUs) 220 through 222, arbitrators 230 through 232, caches 240 through 242, monitor 250, comparator 260, forwarder 270, and basic interface unit 280. Processors 210 through 212 generate requests for memory lines to execute tasks. In some embodiments, processors 210 may include one or more levels of internal caches such as L1 cache and generate external requests for memory lines when the memory lines are not available in the one or more levels of internal caches.

Processors 210 through 212 also include cold start counters 213 through 215. Cold start counters 213 through 215 count cycles from the beginning of a new task to determine when to begin counting cache misses. In particular, when a software application such as an operating system assigns a new task to a processor or interrupts a current task being executed on a processor to perform a different task, the software may set a bit of a register to communicate the task switch to the processor and initiate a count of the cache misses. A large number of cache misses is expected from task switches so, to avoid a premature determination that a task being executed by a processor would operate more efficiently with a larger number of cache lines, cold start counters 213 through 214 couple with counters 252 though 254 of monitor 250 to reset the counter in response to receipt of a new task and prevent the counters from determining cache miss rates for the corresponding processors until a cold start, warm-up period has elapsed. For instance, cold start counter 213 may be set to delay anticipation of a cache miss rate for processor 210 for 10,000 cycles after a new task is introduced.

In some embodiments, the period of delay set for each or all of the cold start counters 213 through 215 may be pre-defined, set by a software application based upon the task to be executed, determined heuristically, or determined by another means. For example, a software application may retain historical data about the number of cache misses related to a task to determine an average number of cycles before the cache misses reach a steady state. The software application may then store the number of cycles in register and load that number of cycles in a cold start counter the next time the task is assigned to a processor.

When processors 210 through 212 reset cold start counters in response to initiation of new tasks, indication of the new tasks may also be transmitted to forwarder 270. In some embodiments, an indication for a processor may reset a bit in enabler 272 corresponding to the processor to disable a cache line re-allocation scheme for that processor. In particular, when a new task begins execution in processor 210, cold start counter 212 is reset to delay a determination of the cache miss rate for processor 210 and a signal is transmitted to forwarder 270 to disable the cache line re-allocation scheme for processor 210 until the cold start counter has expired.

CIUs 220 through 222 are queues or buffers that hold cache requests from the processor until the cache requests can be forwarded to cache such as caches 240 through 242. For instance, when processor 210 generates a request for a memory line and is unable to satisfy the request from cache within processor 210, processor 210 transmits the request to CIU 220. CIU 220 may include a first in, first out (FIFO) queue that retains the cache requests to transmit to cache 240 in order. When the cache request reaches the top of the queue, the cache request is forwarded to cache 240 to determine whether the corresponding memory line is stored in a cache line of cache 240. When a cache line in cache 240 includes the contents of the memory line, access of the cache line is noted to update a least recently used cache line table such as LRU table 274 of forwarder 270 and the memory line is returned to processor 210 for processing. On the other hand, when cache 240 does not have a cache line to satisfy the cache request, and the cache request is associated with processor 210, an indication of a cache miss is forwarded to monitor 250. The cache request may then be forwarded to forwarder 270.

Monitor 250 tracks cache misses for processors 210 through 212. Monitor 250 may include counters 252 through 254 to count the number of cache misses associated with each of the processors. For instance, when cold start 213 has enabled counter 252 to begin counting cache misses for processor 210, counter 252 may increment a number upon receipt of each indication of a cache miss from cache 240.

Comparator 260 accesses counters 252 through 254 to compare the cache miss rates of processors 210 through 212. Comparator 260 may include averager 262 to determine an average cache miss rate for processors 210 through 212 and the average may then be compared against each individual cache miss rate for processors 210 through 212. If one or more of the cache miss rates for individual processors exceeds the average cache miss rate by a pre-determined a threshold level, comparator 260 indicates the processors having high cache miss rates to forwarder 270. For example, comparator 260 may set a bit in enabler 272 for each processor that has a significantly higher than average cache miss rate.

Forwarder 270 is generally configured to determine when to implement a cache line re-allocation scheme for a processor, which cache(s) to target for the re-allocation, and the extent of the re-allocation. In a particular embodiment, forwarder includes enabler 272 and LRU table 274. Enabler 272 includes a bit for each processor 210 through 212. When a bit is set, forwarder 270 may select the least recently used cache line from LRU table 274 and directs the cache requests for the processor associated with the bit to the CIU for the cache line marked as least recently used. For example, bits may be set for processor 211 and 212 and cache 240 has two of the least recently used cache lines in accordance with LRU table 274. When forwarder 270 receives two cache requests, one from processor 211 and one from processor 212, forwarder 270 transmits the two cache requests to CIU 220 via arbitrator 230. For some embodiments, forwarder 270 may continue to increase the number of cache lines allocated to processor 212 until the portion of cache lines utilized by processor 212 with respect to use by other processors is proportional to the difference in the cache miss rates between processor 112 and the other processors.

Arbitrators 230 through 232 coordinate placement of one or more cache requests into CIUs 220 through 222. For example, arbitrator 230 may forward two cache requests to CIU 220 in an order such as the cache request from processor 211 on an odd cycle and the cache request from processor 212 on an even cycle. In some embodiments, for instance, arbitrator 230 may associate a cache request with a pending cache request in a CIU 220 when the pending cache request is associated with the same memory line. In further embodiments, arbitrator 230 may forward each cache request to a queue entry reserved for arbitrator 230.

Basic interface unit (BIU) 280 provides an interface between main memory and cache request forwarder 270. More specifically, when a cache request cannot be satisfied by a cache, i.e. the memory line associated with the cache request is not stored in cache, the cache request is forwarded to main memory to retrieve the corresponding memory line. In other embodiments, one or more additional levels of cache (e.g., level three or higher) may reside between main memory and caches 240, 241, and 242.

### An Exemplary Method

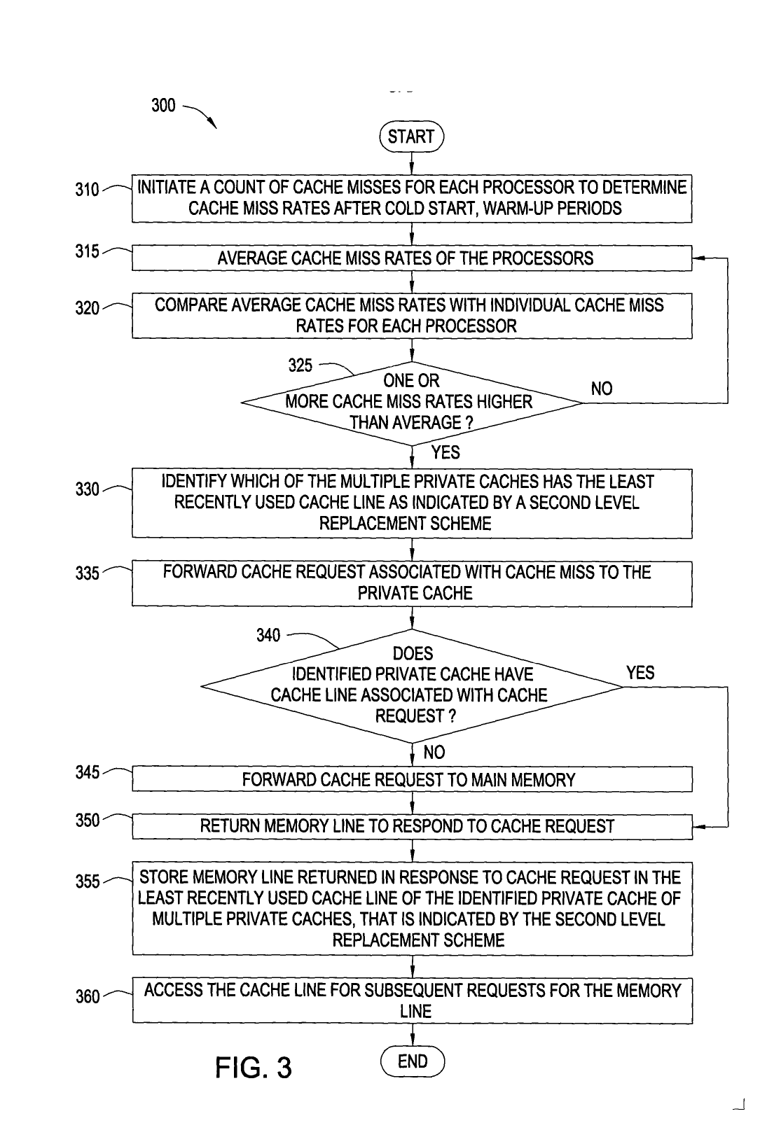

FIG. 3 depicts an example of a flow chart 300 for a method for reducing cache miss rates, for example, utilizing the techniques and apparatus described above. The method begins with step 310 by initiating counts of cache misses for each processor after corresponding cold start, warm-up periods. In particular, after a processor begins a new task, a count representing a cold start, warm-up period begins. After the cold start, warm-up period ends, a counter begins counting cache misses associated with that processor to determine a cache miss rate.

The cache miss rates for each processor are averaged (step 315) and the average cache miss rate is compared with the individual cache miss rates for each processor (step 320) to determine whether a cache line re-allocation scheme will be implemented for one or more of the processors. When the cache miss rates one or more of the processors significantly exceeds the average cache miss rate, e.g., by a pre-determined threshold (step 325), a cache line re-allocation scheme may be enabled for each of the corresponding processors. In many embodiments, the cache line re-allocation scheme may not be enabled unless the cache miss rate of a processor is higher than a threshold cache miss rate based upon the average cache miss rate such as the average cache miss rate plus ten percent. In some embodiments, when the cache miss rates are all higher than a pre-defined threshold cache miss rate, the cache line re-allocation scheme may be enabled for each of the processors. For example, a flag in a register may be set to enable the cache line re-allocation scheme for a processor.

When the cache line re-allocation scheme is not enabled for one or more of the processors, the cache requests associated with those processors may be forwarded to main memory to retrieve the memory lines associated with the cache requests. In such situations, the cache miss rates of each of the processors are continually monitored to determine when the instantaneous cache miss rates exceed an average of the instantaneous cache miss rates in steps 315 and 320.

When the cache re-allocation scheme is enabled for a processor, and the processor realizes a cache miss, a private cache of the multiple private caches, having the least recently used cache line (LRU) is identified via a second level cache line replacement scheme (step 330). In many embodiments, the second level cache line replacement scheme continually tracks the LRU cache lines in an LRU table for each private cache. Thus, when a cache miss is encountered for a processor having the cache re-allocation scheme enabled, the corresponding cache request is forwarded to the private cache having the LRU cache line to replace that cache line with a memory line associated with the cache request (step 335) until the number of cache lines used by the processor is proportionate to the difference in cache miss rates between the processor and other processors.

Before replacing the cache line, however, the private cache is checked to see if the memory line corresponding to the request is already stored in a cache line (step 340). If the memory line is already available, the memory line is returned to the processor from that private cache (step 350). On the other hand, when the memory line is not stored in a cache line of the private cache, the cache request is forwarded to main memory to retrieve the memory line (step 345), the memory line is returned to the processor (step 350), and the memory line is stored in the LRU cache line in the private cache (step 355). Then, the memory line is available in the private cache for subsequent cache requests from the processor or other processors. Once the memory line is available for subsequent cache requests, the cache requests associated with that memory line are forwarded to the private cache to access the memory line (step 360).

While the foregoing is directed to embodiments of the present invention, other and further embodiments of the invention may be devised without departing from the basic scope thereof, and the scope thereof is determined by the claims that follow.

1. A method for reducing latencies associated with accessing memory for more than one processors, each coupled with an associated private cache, the method comprising:
determining cache miss rates of the more than one processors when issuing cache requests against one or more private caches;
comparing the cache miss rates of the more than one processors; and
allocating cache lines from more than one of the private caches to a processor of the more than one processors based upon the difference between the cache miss rate for the processor and the cache miss rates of other processors.

2. The method of claim 1, wherein determining the cache miss rates comprises counting cache misses of each of the more than one processors.

3. The method of claim 1, wherein allocating cache lines comprises forwarding cache requests from the processor to a private cache associated with another processor.

4. The method of claim 1, wherein allocating cache lines comprises selectively allocating cache lines based upon a priority associated with a cache request of the processor.

5. A method for reducing cache miss rates for more than one processors, wherein the more than one processors couple with private caches, the method comprising:
monitoring the cache miss rates of the more than one processors;
comparing the cache miss rates of the more than one processors to determine when a cache miss rate of a first processor associated with a first private cache of the private caches exceeds a threshold cache miss rate for the more than one processors;
forwarding a cache request associated with the first processor to a second private cache of the private caches in response to determining the cache miss rate exceeds the threshold cache miss rate;
replacing a cache line in the second private cache with a memory line received in response to the cache request; and
accessing the cache line in response to an instruction from the first processor.

6. The method of claim 5, wherein monitoring the cache miss rates comprises counting cache misses after a cold start, warm-up period.

7. The method of claim 5, wherein comparing the cache miss rates comprises comparing the cache miss rates, the cache miss rates being associated with more than one processor modules.

8. The method of claim 5, wherein the threshold cache miss rate is based upon an average cache miss rate for the more than one processors.

9. The method of claim 5, wherein forwarding the cache request comprises selecting the second private cache based upon a least recently used cache line associated with the private caches.

10. The method of claim 9, wherein selecting the second private cache comprises selecting a least recently used cache line based upon a processor module on which the first processor resides.

11. The method of claim 5, wherein forwarding the cache request comprises selecting the cache request based upon a priority associated with the cache request.

12. The method of claim 5, wherein forwarding the cache request is responsive to a software instruction that overrides a result of comparing the cache miss rates to forward the cache request to the second private cache.

13. An apparatus for reducing cache miss rates for more than one processors, wherein the more than one processors couple with private caches, the apparatus comprising:
a cache miss rate monitor configured to determine the cache miss rates of the more than one processors when issuing cache requests against the private caches;
a cache miss rate comparator configured to compare the cache miss rates; and
a cache request forwarder configured to allocate cache lines from more than one of the private caches to a cache request of a processor of the more than one processors based upon the difference between the cache miss rate for the processor and the cache miss rates of other processors.

14. The apparatus of claim 13, wherein the cache miss rate monitor comprises a plurality of counters, each configured to count cache misses of a corresponding one of the more than one processors.

15. The apparatus of claim 13, wherein the cache request forwarder is adaptable to forward cache requests from the processor to a private cache associated with another processor.

16. The apparatus of claim 13, wherein the cache request forwarder is adapted to selectively allocate cache lines based upon a priority associated with a cache request of the processor.

17. The apparatus of claim 13, wherein the cache request forwarder comprises a least recently cache line table to determine which cache line to allocate for use with the processor.

18. An apparatus adapted to reduce the latency for accessing memory coupled thereto, comprising:
more than one processors to issue cache requests;
more than one private caches, each individually coupled with one of the more than one processors;
a cache miss rate monitor to determine a cache miss rate with each of the more than one processors;
a cache miss rate comparator to determine when at least one of the cache miss rates exceeds a threshold; and
a cache request forwarder to forward a cache request from a processor of the more than one processors that is associated with a cache miss rate determined to exceed the threshold, to a private cache of the more than one private caches associated with another processor of the more than one processors.

19. The apparatus of claim 18, wherein the more than one processors and the more than one private caches reside on more than one processor modules.

20. The apparatus of claim 18, wherein the cache miss monitor comprises more than one cache miss counter, each coupled with one of the more than one processors, to start a count of cache misses after a cold start warm-up period.

21. The apparatus of claim 18, wherein the cache miss comparator comprises a rate averager to compare the cache miss rates to determine when the cache miss rate of the processor exceeds an average cache miss rate associated with the more than one processors.

22. The apparatus of claim 18, wherein the cache request forwarder is responsive to a software instruction to forward cache requests from one of the more than one processors to the private cache.

23. The apparatus of claim 18, wherein the cache request forwarder is adapted to select the private cache based upon a least recently used cache line associated with the private caches.

24. The apparatus of claim 23, wherein the cache request forwarder is adapted to select the private cache based upon a processor module on which the private cache resides.

25. The apparatus of claim 17, wherein the cache request forwarder is adapted to select the cache request based upon a priority associated with the cache request.

26. The apparatus of claim 17, wherein the cache request forwarder inserts the cache request into a cache request queue for the private cache to store the memory line in the private cache.

27. The apparatus of claim 26, wherein the cache request forwarder comprises an arbitrator to arbitrate between the cache request and another cache request from another processor of the more than one processors, to forward the cache request to the cache request queue.

28. A system, the system comprising:
a processor module comprising a first processor coupled with a first private cache and a second processor coupled with a second private cache;
a cache miss rate monitor to count cache misses associated with the first processor and the second processor;
a cache miss rate comparator to compare the cache misses associated with the first processor against cache misses associated with the second processor; and
a cache request forwarder to forward cache requests from the first processor to the second private cache when a number of cache misses associated with the first processor, related to the first private cache, exceeds a number of cache misses associated with the second processor.

29. The system of claim 28, further comprising a historical use file containing a set of one or more tasks and associated cache miss rate information.

30. The system of claim 29, further comprising a software application to enable the cache request forwarder to forward the cache requests based upon the difference between the number of cache misses associated with the first processor and the number of cache misses associated with the second processor.

31. The system of claim 28, wherein the cache request forwarder allocates cache lines of the first private cache and the second private cache based upon the difference between the cache miss rates of the first processor and the second processor.

32. The system of claim 28, wherein the cache request forwarder forwards cache requests from a first processor module of the more than one processor modules to a second processor module of the more than one processor modules, the second module having a least recently used cache line.

33. A computer readable medium containing a program which, when executed, performs an operation, comprising:
determining cache miss rates of more than one processors when issuing cache requests against one or more private caches;
comparing the cache miss rates; and
allocating cache lines from more than one of the private caches to a processor of the more than one processors based upon a difference between the cache miss rate for the processor and the cache miss rates of other processors.

34. The computer readable medium of claim 33, wherein allocating cache lines comprises forwarding cache requests from the processor to a private cache of the private caches, wherein the private cache is associated with another processor.

35. The computer readable medium of claim 33, wherein allocating cache lines comprises selectively allocating cache lines based upon a priority associated with a cache request of the processor.

36. A computer readable medium containing a program which, when executed, performs an operation, comprising:
monitoring cache miss rates of more than one processors;
comparing the cache miss rates of the more than one processors to determine when a cache miss rate of a first processor associated with a first private cache exceeds a threshold cache miss rate for the more than one processors;
forwarding a cache request associated with the first processor to a second private cache in response to determining the cache miss rate exceeds the threshold cache miss rate;
replacing a cache line in the second private cache with a memory line received in response to the cache request; and
accessing the cache line in response to an instruction from the first processor.

37. The computer readable medium of claim 36, wherein comparing the cache miss rates comprises comparing the cache miss rates, the cache miss rates being associated with more than one processor modules.

38. The computer readable medium of claim 36, wherein the threshold cache miss rate is based upon an average cache miss rate for the more than one processors.

39. The computer readable medium of claim 36, wherein forwarding the cache request comprises selecting the second private cache based upon a least recently used cache line associated with the private caches.

40. The computer readable medium of claim 39, wherein selecting the second private cache comprises selecting a least recently used cache line based upon a processor module on which the first processor resides.

41. The computer readable medium of claim 36, wherein forwarding the cache request comprises selecting the cache request based upon a priority associated with the cache request after the cache request misses in the first private cache.

42. The computer readable medium of claim 36, wherein forwarding the cache request is responsive to a software instruction that overrides a result of comparing the cache miss rates to forward the cache request to the second private cache.
